(19) United States
(12) Patent Application Publication
(10) Pub. No.: US 2022/0370967 A1
(43) Pub. Date: Nov. 24, 2022

(54) EMULSIFICATION DEVICE AND EMULSIFICATION METHOD

(71) Applicant: Acudx Inc., Cupertino, CA (US)

(72) Inventor: Xitong Li, Cupertino, CA (US)

(21) Appl. No.: 17/773,817

(22) PCT Filed: Nov. 11, 2020
(86) PCT No.: PCT/US2020/059952

§ 371 Date: May 2, 2022

Related U.S. Application Data
(60) Provisional application No. 62/935,210, filed on Nov. 14, 2019.

(51) Int. Cl. B01F 25/313; B01F 23/41; B01F 33/3011; B01F 35/71

(52) U.S. Cl. CPC B01F 25/3133; B01F 23/4145; B01F 23/4105; B01F 33/3011; B01F 35/71745; B01F 2101/23

(57) ABSTRACT

An emulsification device disclosed herein comprises: an outer tank having a first pressing end and a first exit end; and an inner tank having a second pressing end and a second exit end, wherein the inner tank is disposed inside the outer tank and the second exit end is located closer than the second pressing end to the first exit end, the outer tank is configured to house a first liquid and the inner tank is configured to house a second liquid, the first and second pressing ends are arranged so that one pressure can be applied onto both the first and second liquids, and under the pressure, the second liquid flows out of the inner tank through the second exit end and contacts with the first liquid in the outer tank so that an emulsion droplet comprising the second liquid within the first liquid is formed.

### RELATED APPLICATION

This application claims priority to and is entitled to the benefit of U.S. Provisional Application No. 62/935,210, filed on Nov. 14, 2019. The entire content of said provisional application is herein incorporated by reference for all purposes.

### FIELD OF THE INVENTION

The present disclosure relates to a technical field of emulsification, and particularly to an emulsification device and an emulsification method.

### BACKGROUND OF THE INVENTION

Emulsification is a process of dispersing a first liquid in a second immiscible liquid to form an emulsion. Emulsification technology is widely used across different industries and has advanced significantly with the development of the microfluidic process. Compared to conventional emulsification technologies, the microfluidics-based process can produce droplets of controlled volume and distribution. Commonly used microfluidic-based emulsification devices typically are based on a T-junction design or a flow-focusing design, as illustrated in FIG. 1A and FIG. 1B. Such a device carries a dispersed phase referring to the liquid, which will form droplets, and a continuous phase referring to another liquid, which is immiscible to the dispersed phase and will surround the formed droplets.

FIG. 1A shows an example of the T-junction design, which currently is considered as the simplest and most commonly used droplet-generation device. In a device according to the T-junction design, the dispersed phase is injected perpendicularly to the flow of the continuous phase to generate microfluidic droplets. When the immiscible fluids arrive at the T-junction of the two channels, the dispersed phase progressively enters the main channel. The continuous phase shears at this point. The dispersed phase then forms a bend 101 at the interface of the two fluids. The more the dispersed phase advances in the main channel, the more the elbow 102 of the bend 101 narrows to a break in the continuity of the interface. The break generates the detachment of a drop that continues to move in the direction of the flow of the channel.

FIG. 1B shows an example of the flow-focusing design. In the flow focusing design, the dispersed phase is introduced directly into the main channel 201 while the continuous phase is injected by two perpendicular branches 202 and 203. The dispersed phase is then pinched on both sides by the continuous phase. A droplet is then formed due to the competition between the viscous force and the surface tension at the interface between the two phases.

These designs are complex and are not able to produce consistent results in an economical manner.

### SUMMARY OF THE INVENTION

In some embodiments, an emulsification device disclosed herein comprises an outer tank, an inner tank, and a pressure source. The outer tank is configured to house a first liquid, and the outer tank comprises a first pressing end and a first exit end. The first pressing end is configured to pass a pressure from the pressure source onto the first liquid, and the first exit end has an opening through which the first liquid flows out under the pressure. The inner tank configured to house a second liquid, and the inner tank comprises a second pressing end and a second exit. The second pressing end is configured to pass a pressure onto the second liquid, and the second exit end has an opening through which the second liquid flows out under the pressure. The inner tank is inside the outer tank. The pressure source is configured to be connected to the first pressing end and to provide a pressure. When the pressure is applied to the first pressing end from the pressure source, said pressure is also simultaneously passed and applied through the second pressing end. In some embodiments, the first liquid and the second liquid are immiscible.

In some embodiments, the first pressing end, the second pressing end, the second exit end and the first exit end of the emulsion device are sequentially aligned in order of the first pressing end, the second pressing end, the second exit end and the first exit end.

In some embodiments, the first pressing end is flush with the second pressing end, and the second pressing end, the second exit end and the first exit end of the emulsion device are sequentially aligned in order of the second pressing end, the second exit end, and the first exit end.

In some embodiments, an emulsification method disclosed herein comprises:

providing an emulsification device comprising an outer tank and an inner tank,

wherein the outer tank is filled with a first liquid and the inner tank is filled with a second liquid,

wherein the inner tank filled with the second liquid is inside the outer tank filled with the first liquid,

thereby the first pressing end, the second pressing end, the second exit end and the first exit end are sequentially aligned in order of the first pressing end, the second pressing end, the second exit end and the first exit end;

applying a pressure to the first liquid through a pressure source connected to the first pressing end, wherein the pressure is simultaneously passed through the second pressing end and applied to the second liquid, wherein under the pressure the first liquid flows towards the first exit, and the second liquid flows towards the second exit end,

wherein the second liquid flows out of the second exit end and contacts the first liquid flowing out of the first exit, resulting in formation of emulsion droplets comprising the second liquid within the first liquid.

In some embodiments, the outer tank that has a volume less than 5000 μl, and the inner tank has a volume less than 4000 μl, wherein the outer tank is filled with the first liquid, and wherein the inner tank is filled with the second liquid.

In some embodiments, the first exit end is open and has an opening, wherein the opening of the first exit end has a linear size less than 5000 microns; and the second exit end is open and has an opening, wherein the opening of the second exit end has a linear size less than 4000 microns.

In some embodiments, an emulsification device disclosed herein comprises

an outer tank having two opposite ends, one of which is a first pressing end and the other is a first exit end; and

an inner tank having two opposite ends, one of which is a second pressing end and the other is a second exit end,

wherein when the emulsification device is in use, the inner tank is disposed inside the outer tank and the second exit end is located closer than the second pressing end to the first exit end, the outer tank is configured to house a first liquid and the inner tank is configured to house a second liquid, the first and second exit ends are open, and the first and second pressing ends are arranged so that a pressure can be applied simultaneously onto both the first and second liquids from the first and second pressing ends, and

wherein under the pressure, the first liquid flows towards the first exit end and the second liquid flows towards the second exit end,

wherein the second liquid flows out of the inner tank through the second exit end and contacts with the first liquid in the outer tank, thereby an emulsion droplet comprising the second liquid within the first liquid is formed out of the second exit end.

In some embodiments, the inner tank and the outer tank are arranged so that the first pressing end, the second pressing end, the second exit end and the first exit end are sequentially aligned in order of the first pressing end, the second pressing end, the second exit end and the first exit end.

In some embodiments, the second pressing end is flush with the first pressing end, and wherein the second pressing end, the second exit end and the first exit end are sequentially aligned in order of the second pressing end, the second exit end and the first exit end.

In some embodiments, the first exit end has a linear size so that the first liquid at the first exit end has a surface tension sufficient to keep the first liquid from flowing out of the outer tank without applying the pressure onto the first liquid; and the second exit end has a linear size so that the second liquid at the second exit end has a surface tension sufficient to keep the second liquid from flowing out of the inner tank without applying the pressure onto the second liquid.

In some embodiments, the device comprises a pressure source which is configured to provide a single pressure onto both the first liquid from the first pressing end and the second liquid from the second pressing end.

In some embodiments, the pressure source is a gas pump, and when the emulsification device is in use, a pressured gas is supplied from the gas pump onto both the first and second liquids.

In some embodiments, the first pressing end is sealed with a lid so that the whole body of the inner tank with the second pressing end is contained in the outer tank, and the pressured gas is supplied into the outer tank after passing through a hole of the lid.

In some embodiments, the device further comprises a holder disposed inside the outer tank, wherein the holder holds the inner tank inside the outer tank.

In some embodiments, the emulsification device further comprises a means for holding the inner tank inside the outer tank.

In some embodiments, the holder is a plate having an edge part configured to be attached with an inner wall of the outer tank, and there is a first hole and one or more second holes on the plate,

wherein the first hole is configured for holding the inner tank inside the outer tank, and the one or more second holes are configured for the first liquid in the outer tank to flow through.

In some embodiments, the second exit end has a linear size smaller than the linear size of the first exit end.

In some embodiments, the first exit end has a linear size ranging from 0.01 mm to 2.0 mm, and the second exit end has a linear size ranging from 0.007 mm to 1.8 mm.

In some embodiments, each of the outer tank and the inner tank has a tapered shape.

In some embodiments, each of the outer tank and the inner tank comprises a top section having a cylinder shape with a first diameter, a bottom section having a cylinder shape with a second diameter smaller than the first diameter, and a third section having a shape of a truncated cone, wherein the truncated cone connects the top section and the bottom section,

wherein the first pressing end is one end of the top section of the outer tank,

wherein the second pressing end is one end of the top section of the inner tank,

wherein the first exit is one end of the bottom section of the outer tank, and

wherein the second exit is one end of the bottom section of the inner tank.

Also provided herein is an emulsification method implemented with an emulsification device comprising an outer tank and an inner tank, wherein the emulsification method comprises:

filling the outer tank with a first liquid, and filling the inner tank with a second liquid, wherein filling the outer tank and filling the inner tank can be in any order, wherein the outer tank has two opposite ends, one of which is a first pressing end and the other is a first exit end which is open, the inner tank has two opposite ends, one of which is a second pressing end and the other is a second exit end which is open, and the inner tank is disposed inside the outer tank in such a manner that the second exit end is located closer than the second pressing end to the first exit end;

applying a pressure onto the first and second liquids simultaneously from the first and second pressing ends so that under the pressure, the first liquid flows towards the first exit end and the second liquid flows towards the second exit end, wherein the second liquid flows out of the inner tank through the second exit end and contacts with the first liquid in the outer tank to form an emulsion droplet comprising the second liquid within the first liquid.

In some embodiments, the first liquid is in an oil phase, and the second liquid is in an aqueous phase.

In some embodiments, the first and/or the second liquid comprise one or more surfactants.

In some embodiments, the emulsification method further comprises:

adjusting total number of droplets to be generated by changing a volume of the inner tank, e.g., increasing or decreasing the total number of droplets by increasing or decreasing the volume of the inner tank, wherein the inner tank is filled with the second liquid.

The emulsification device in the embodiments as described above and other embodiments of the present disclosure has a simple structure, easy to arrange, easy to manufacture and thereby has a relatively low cost. Embodiments of the emulsification method implemented with the emulsification device can be easily implemented and have simpler steps for forming an emulsion.

Other aspects and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### BRIEF DESCRIPTION OF THE DRAWINGS

The novel features of the invention are set forth with particularity in the appended claims.

A better understanding of the features and advantages of the present invention will be obtained by reference to the following detailed description that sets forth illustrative embodiments, in which the principles of the invention are used, and the accompanying drawings of which:

FIGS. 1A and 1B illustrate examples of a T-junction design, and a flow-focusing design for a microfluidic-based emulsification device in the prior art, respectively.

FIG. 2 depicts one exemplary embodiment of the outer tank of the emulsification device.

FIG. 3 depicts one exemplary embodiment of the inner tank of the emulsification device according to an embodiment of the present application.

FIG. 4 depicts one exemplary embodiment of the emulsification device in use in which the inner tank is placed inside the outer tank according to an embodiment of the present application.

FIG. 5 depicts another exemplary embodiment of the emulsification device in use which comprises a holder and holder holds the inner tank inside the outer tank. The device is connected to a pressure source.

FIG. 6 depicts an example of the holder of the emulsification device according to an embodiment of the present application.

FIG. 7 depicts a flow chart of an exemplary embodiment of the emulsification method according to an embodiment of the present application.

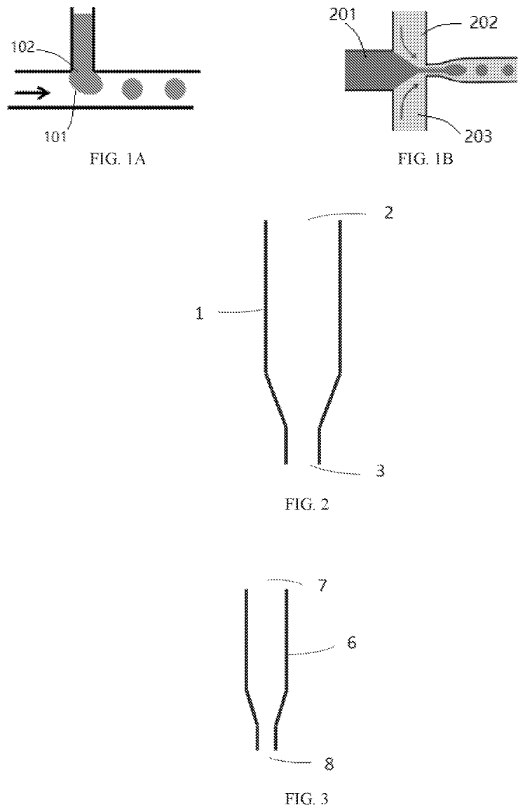

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “tank” as used herein, refers to a container or the like, which can receive or contain liquids as required in the present disclosure. The term “tank” does not intend to limit the shape or configuration, the material, the dimensions, or the manufacturing method of the container. For example, the tank can be of any shape, such as a tube, a funnel, a cuboid, etc.

The term “about” when used in conjunction with a value means any value that is reasonably close to the value, i.e., within the range of ±10% of the value, including the value itself. For example, 11, 10, and 9 are all deemed to be “about 10.”

The term “in use,” refers to the status of the emulsification device, in which both tanks of the emulsification device are filled with liquids and droplets are generated from the device.

The term “inside,” when used to describe the spatial relationship between the inner tank and the outer tank, refers to no portion of the inner tank is outside the outer tank.

As used herein, the term “linear size” with regard to an opening (e.g., the first exit end or the second exit end when they are open) refers to the diameter of the minimum bounding circle that completely contains the cross-section area of the opening.

As used herein, the term “pitch” hereinafter means the average distance between the produced emulsion droplets.

### Immiscible Liquids For Droplet Generation

The disclosure provides embodiments of a device and a method for forming an emulsion comprising a liquid within another liquid, wherein the two liquids are immiscible and when the first liquid is mixed with the second liquid, an emulsion forms. For example, the first liquid may be a hydrophobic liquid, and the second liquid may be a hydrophilic liquid, and vice versa. In one embodiment, the first liquid is oil, and the second liquid is a reaction mixture (e.g., a PCR reaction mixture). The device or method may be applied as a standalone device or method, or as part of an integrated system. It shall be understood that different aspects of the disclosure can be appreciated and practice individually, collectively, or in combination with each other.

### Outer Tanks and Inner Tanks

In accordance with an aspect of the invention, an emulsification device comprises an outer tank and an inner tank. In general, the inner tank has a dimension and volume that is smaller than the outer tank so that it can be placed inside the outer tank. Each of the outer tank and the inner tank may have two opposite ends, one of which is a pressing end, configured to receive a pressure and the other is an exit end, from which a liquid can flow out. When the emulsification device is in use, the inner tank can be placed and held inside the outer tank in such a manner that the exit end of the inner tank is closer to the exit end of the outer tank than the pressing end of the inner tank is. That is, the inner tank is contained inside the outer tank to form the emulsification device, with the two pressing ends of the inner and outer tanks at one end of the emulsification device, and the two exit ends at the other end of the emulsification device.

FIG. 2 illustrates an exemplary embodiment of the outer tank of an emulsification device disclosed herein. The outer tank is configured to house a first liquid. As shown in FIG. 2, the outer tank (oTK) comprises a housing 1, a first pressing end 2 and a first exit end 3. The first pressing end 2 and the first exit end 3 are opposite ends of the housing 1. When the emulsification device is in use, both the first pressing end 2 and the first exit end 3 are open, and when a pressure is applied onto the first liquid from the first pressing end 2, the first liquid will flow through the outer tank and exit the outer tank through the first exit end 3.

FIG. 3 shows an exemplary embodiment of the inner tank of an emulsification device disclosed herein. In the example, the inner tank (iTK) has a housing 6, a second pressing end 7 and a second exit end 8. The second pressing end 7 and the second exit end 8 are opposite ends of the housing 6. When the emulsification device is in use, both the second pressing end 7 and the second exit end 8 are open. The inner tank is disposed inside the outer tank and configured to house a second liquid, and when a pressure is applied onto the second liquid from the second pressing end 2, the second liquid will flow through the inner tank and exit the inner tank through the second exit end 8.

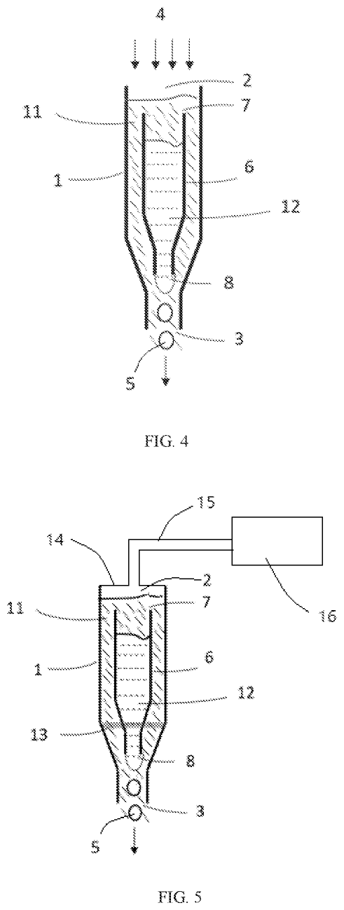

FIG. 4 shows an exemplary embodiment of the emulsification device in use comprising the inner tank, as shown in FIG. 3, inside the outer tank, as shown in FIG. 2. The outer tank is configured to house the first liquid 11, and the inner tank is configured to house the second liquid 12. The first liquid 11 and the second liquid 12 are immiscible. In one embodiment, the first liquid 11 is in an oil phase, and the second liquid 12 is in an aqueous phase.

As shown in FIG. 4, the first pressing end 2 and the second pressing end 7 are at one end of the emulsification device. This configuration allows a single pressure 4 to be conveniently applied onto both the first liquid 11 from the first pressing end and the second liquid 12 from the second pressing end 7, respectively. In this configuration, advantageously, a single pressure can be used to drive the first and second liquids simultaneously, allowing droplets to emerge from the second exit end 8 then to exit from the first exit end 3. Under the pressure, the first liquid 11 flows towards the first exit end 3, and the second liquid 12 flows towards the second exit end 8. In the arrangement as shown in FIG. 4, the second liquid 12 flows out of the inner tank through the second exit end 8 and contacts the first liquid 11 at the interface of the first and second liquids, the interface being formed at the second exit end 8. During the contact, the first liquid 11 bulges into the second liquid 12. The bulge then becomes bigger and eventually is pushed off by the second liquid 12 and forms a droplet. Then the next bulge begins, and the droplets of the first liquid 11 are sequentially formed into the second liquid. The emulsion will then flows from the second exit end 8 towards the first exit end 3.

In the exemplary embodiment as shown in FIG. 4, the inner tank and the outer tank are arranged in such a manner that the first pressing end 2, the second pressing end 7, the second exit end 8, and the first exit end 3 are sequentially aligned in order of the first pressing end 2, the second pressing end 7, the second exit end 3 and the first exit end 8. That is, when the emulsification device is placed in the direction as shown in FIG. 4, the level of the first pressing end 2 is higher than that of the second pressing end 7, and the level of the first exit end 3 is lower than that of the second exit end 8. However, modifications and changes can be made. In another embodiment, the second pressing end 7 can be flush with the first pressing end 2.

As mentioned above, the first and second liquids 11 and 12 can flow out of the outer and inner tanks under the pressure 4. In some embodiments, without the pressure, the first and second liquids 11 and 12 are kept static in the outer and inner tanks although the first and second exit ends 3 and 8 are open. In these embodiments, the linear size of the first exit end and second exit end are within suitable ranges such that the first or second liquid at the first or second exit end has a surface tension sufficient to keep the first or second liquid from flowing out of the outer or inner tank without applying the pressure. In general, the smaller the linear size of the first exit end, the easier to keep the first liquid from flowing out of the first tank. Likewise, the smaller the linear size of the second exit end, the easier to keep the second liquid from flowing out of the first tank.

In general, the linear size of each of the first and second exit ends is designed to be small. In one embodiment, the first exit end 3 has a linear size ranging from 0.01 mm to 2.0 mm, e.g., from 0.05 mm to 1 mm, or from 0.2 mm to 1 mm. and the second exit end 8 has a linear size ranging from 0.007 mm to 1.8 mm, e.g., from 0.01 mm to 1.5 mm, from 0.05 to 1.2 mm, or from 0.1 mm to 1 mm. In some embodiments, the opening of the second exit end 8 is designed to have a linear size smaller than the linear size of the opening of the first exit end 3 such that even the second exit end 8 is inserted into the first exit end 3; there is still a gap therebetween. In some embodiments, the opening of the first exit end has a linear size less than 5000 microns, and opening of the second exit end has a linear size less than 4000 microns.

The inner and outer tanks can be of any shape or configuration as long as they are suitable to contain the first and second liquids or other liquids as needed. For example, the inner and outer tanks each can be of a tube shape. In another example, the inner and outer tanks each has a tapered shape, with the pressing end having a linear size bigger than that of the exit end.

In the embodiments shown in FIGS. 2-6, each of the outer tank and the inner tank comprises a top section having a cylinder shape with a first diameter, a bottom section having a cylinder shape with a second diameter, which is smaller than the first diameter, and a third section having a shape of a truncated cone and disposed between and connected to the top cylinder and the bottom cylinder, wherein the first or second pressing end is one of ends of the top section and the first or second exit end is one of ends of the bottom section. It can be understood, however, that these are only exemplary embodiments, and many modifications or changes can be made to these embodiments in terms of the shape of the outer or inner tank.

As shown in the embodiment of FIG. 4 or 5, the inner tank has a shape similar to the shape of the outer tank. It can be understood that they can have different shapes as long as the inner tank can be placed inside the outer tank.

In one illustrative embodiment of the device, as depicted in FIG. 4, the first pressing end 2 of the outer tank has a linear size of about 8 mm, the total height of the outer tank is about 30 mm, and the linear size of the first exit end 3 is about 0.3 mm. The first liquid 11 contained in the outer tank has a volume of about 1500 μl, and the second liquid 12 contained in the inner tank has a volume of about 100 μl.

As shown in the embodiment of FIG. 4 or 5, when the device is placed upright, the first liquid 11 has a level higher than that of the second liquid. But it is not necessary to maintain the first liquid 11 as a higher level than the second liquid in order to form an emulsion. In other embodiments, the first liquid 11 can have a level lower than or equal to that of the second liquid.

As shown in the embodiment of FIG. 4 or 5, in the inner tank there is first liquid on top of the second liquid. However, it is not necessary for the inner tank to have any of the first liquid on top of the second liquid in order to form an emulsion. In another embodiment, there is no first liquid on top of the second liquid in the inner tank. In some other embodiments, there is the second liquid on top of the first liquid in the outer tank.

As shown in the embodiment of FIG. 4 or 5, the emulsification device is placed upright, and the first and second pressing ends, the second and first exit ends are present in the order from top to bottom. However, being placed upright is not a requirement for the operation of the device. In some other embodiments, the device is placed in other positions, e.g., being placed in an inclined position.

The inner and outer tanks each can be made of any material as long as they can contain the first and second liquids as needed. For example, the inner and outer tank each can be made of plastic, glass, metal, or the like.

The inner and outer tanks each can be made by any manufacturing method. For example, each of them can be made by injection molding. Each of the tanks can be divided into several sections, each section is produced separately, and then these sections are assembled or connected to form the tank. These sections can be made of different materials or by different production methods.

As mentioned above, under a single pressure 4, the first and second liquids flow out of the inner and outer tanks, respectively. In the embodiments of the disclosure, the pressure can be applied onto both the first liquid and the second liquid simultaneously. Applying a single pressure is advantageous because if applying two separate pressures onto first and second liquids respectively, the pressure difference around the second exit end for the first liquid of outer tank and the second liquid of inner tank could cause backflows. For example, the first fluid from the outer tank may back flow into inner tank; or the second fluid from inner tank may back flow into the outer tank. By applying one single pressure, there is no pressure difference around the second exit end so that the first and second liquids can move into the same direction from the second exit end towards the first exit end, without the undesired backflows associated with applying two separate pressures. The pressure 4 can be supplied from a pressure source. The pressure source can be any kind of pressure source that is capable of applying a positive pressure onto the first and second liquids in the tanks. In some embodiments, the pressure source is a gas pump, which supplies a pressured gas into the sealed space on top of the first and second liquids through the first and second pressing ends. In some embodiments, the pressure source is a hydropress, which uses oil, water, or the like as a media to pass a pressure onto both the first and second liquids. In some embodiments, the pressure source is a weighted block.

### Optional Additional Components

### Gas Pump

In some embodiments, the emulsification device is linked to a pressure source, e.g., a gas pump.

FIG. 5 shows an exemplary embodiment of the emulsification device in use with the pressure source 16, which is a gas pump. As shown in FIG. 5, the first pressing end 2 is sealed with a lid 14, and the second pressing end 7 is open and inside the outer tank. The pressure source 16 provides a pressured gas using a pipe 15, which connects the pressure source 16 to the lid of the outer tank. The pipe 15 is connected to the lid 14 through a hole on the lid 14, which enables a fluid communication between the space inside the outer tank and the pressure source. The pressured gas passes through the pipe 15 and arrives the space on top of the first and second liquid (below the lid 14), thereby simultaneously pushing the first and second liquids to flow towards the first and second exit ends.

### Holder

In some embodiment, when during the droplet generation process, the inner tank is held inside the outer tank such that the relative position of the inner tank to the outer tank is kept unchanged, i.e., the inner tank is secured inside the outer tank. Various ways that can be used to hold the inner tank inside the outer tank. In some embodiments, the emulsification device further comprises a holder disposed inside the outer tank. Said holder is configured to hold the inner tank in place inside the outer tank. One illustrative embodiment is shown in FIG. 5, in which a holder 13 is disposed inside the outer tank and configured to hold the inner tank inside the outer tank in place. The holder 13 can receive and hold the inner tank. The holder 13 can be of any shape or any material, provided that it can receive and secure the inner tank in place inside the outer tank and also allows the first liquid 11 flow through during the emulsification process. FIG. 6 shows an example of the holder 13.

One illustrative embodiment of the holder is shown in FIG. 6. The holder is a plate 13 having an edge part 131 configured to be attached to an inner wall of the outer tank. There is a first hole 133 and one or more second holes 132a, 132b on the plate 13. The first hole 133 is configured for the inner tank to pass through so as to receive and hold the inner tank inside the outer tank, and the one or more second holes 132a, 132b are configured for the first liquid 11 in the outer tank to flow through. The plate 13 may have a certain thickness around the first hole 133 so that the inner tank can be held firmly in the first hole 133. In the embodiment shown in FIG. 6, the plate 13 is disk-like so that the edge part 131 of the plate 13 can be attached to the inner wall of the outer tank closely. It can be understood that the plate 13 can be of any other shapes as long as it can be secured to the outer tank. In the embodiment of FIG. 6, the first hole 133 has a circle shape, and the second holes each has an elliptic shape. It can be understood that each of the first and second holes can have a different number and a different shape. In some embodiments, a plurality of the first holes having different sizes and/or shapes are arranged in the plate 13. In some embodiments, the second hole has shape that is different from the elliptic shape.

In an alternative, the position of the inner tank relative to the outer tank (e.g., the position of the second exit relative to the first exit) can be adjusted. For example, the inner tank can be inserted into a holder attached onto outer tank at a different location so that the second exit end of the inner tank is farther away or closer to the first exit end of the outer tank. In another alternative, the inner tank placed inside the outer tank can be replaced with another inner tank with a different volume. The inner tank with the different volume can be inserted into a hole of the holder having a different and appropriate volume.

The emulsification device in the embodiments as described above and other embodiments of the present disclosure has a simple structure. It is easy to assemble and manufacture, therefore has a relatively low production cost. In some embodiments, the position of the inner tank relative to the outer tank can be easily adjusted so that a flow ratio of the first liquid to the second liquid is changed, thereby conveniently changing the volume of the produced emulsion droplet and controlling the pitch of the emulsion droplet generation.

### Method For Droplet Generation

According to another aspect of the present disclosure, an emulsification method implemented with an emulsification device can be provided. The emulsification device can be any of embodiments of the emulsification device of the present disclosure, and said device includes an outer tank and an inner tank.

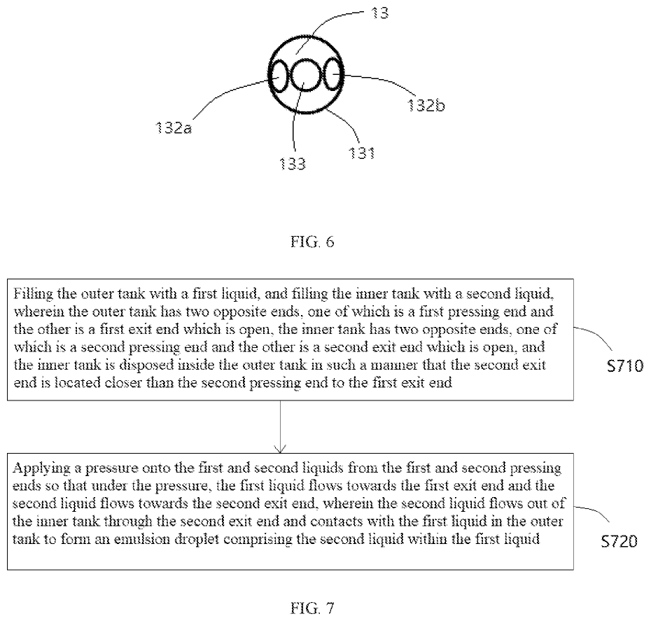

FIG. 7 shows a flow chart of an example of the emulsification method according to an embodiment of the present disclosure. As shown in FIG. 7, the method may include the following steps.

S710, filling the outer tank with a first liquid, and filling the inner tank with a second liquid. wherein the outer tank has two opposite ends, one of which is a first pressing end and the other is a first exit end, and the first exit end is open. The inner tank has two opposite ends, one of which is a second pressing end, and the other is a second exit end, and the second exit end is open. The inner tank is disposed inside the outer tank in such a manner that the second exit end is located closer than the second pressing end to the first exit end. The filling of the outer tank and filling of the inner tank can be performed in any order. In some embodiments, before S710, the inner tank has been disposed inside the outer tank, thus the filling of the outer and inner tanks in S710 does not change the arrangement of the two tanks. In some embodiments, before S710, the inner tank is not disposed inside the outer tank, thus S710 may include disposing the inner tank filled with the first liquid into the outer tank filled with the second liquid.

S720, applying a single pressure onto the first liquid from the first pressing end and the second liquid from the second pressing end, so that under the pressure, the first liquid flows towards the first exit end and the second liquid flows towards the second exit end. The second liquid flows out of the inner tank through the second exit end and contacts with the first liquid in the outer tank to form emulsion droplets, each droplet comprising the second liquid within the first liquid.

As mentioned above, the first and second liquids are immiscible. In one embodiment, the first liquid is in a hydrophobic liquid, and the second liquid is in a hydrophilic liquid. In one embodiment, the first liquid is in an oil, and the second liquid is in an aqueous solution. Under the pressure, the second liquid flows out of the inner tank through the second exit end. As the second liquid flows out of the second exit end, it merges with the first liquid in the outer tank, which results in an emulsion comprising the second liquid droplets within the first liquid.

In some embodiments, it is desirable to maintain the volumes of the produced emulsion droplets within a range suitable for the reactions (e.g., PCR reactions). The volume of produced droplets can range from 1 picoliter to 150 microliter, e.g., from 10 picoliter to 100 microliter, or from 100 picoliter to 1 microliter, or from 1 picoliter to 10 microliter. Most common volumes of the droplets generated by the device range from 1 nanoliter to 100 nanoliter. Controlling the volume of the emulsion droplets can be achieved in various ways. In some embodiments, one or more surfactants are added to the first and/or second liquids to increase the droplet volume. Exemplary surfactants include, but not limited to, poloxamers, polyoxyethylene alkyl ethers, polyoxyethylene fatty acid esters, sorbitan esters, polyoxythylen sorbitan esters, Tween 80, Tween 20, Triton X-100, Span 80, Span 60, Tetronic 701, Brij 58, Brij L4, Pluronic F-68, Pluronic F-127. In some embodiments, one or more surfactants are added to the first liquid only. In some embodiments, one or more surfactants are added to the second liquid only. In some embodiments, one or more surfactants are added to both the first and the second liquids.

In some embodiments, the volumes of the produced emulsion droplets is controlled by controlling the flow ratio of the first liquid to the second liquid. In general, the lower the flow ratio, the larger the droplet size. In some embodiments, the flow ratio is increased by decreasing the linear size of the exit end of the inner tank or replacing the inner tank with another one having a smaller linear size of the exit end of the inner tank. In some embodiments, the flow ratio is decreased by increasing the linear size of the exit end of the inner tank or replacing the inner tank with another one having a larger linear size of the exit end of the inner tank.

With regard to other details of the emulsification device and the emulsification principle or process, please refer to those as described in the embodiments of the emulsification device, which are omitted here for the sake of brevity.

Embodiments of the emulsification method implemented with the emulsification device can be implemented and have simpler steps for forming an emulsion. In some embodiments of the emulsification method, a flow ratio of the first liquid to the second liquid can be adjusted by adjusting the position of the inner tank relative to the outer tank or the volume of the inner tank, thereby changing the volume of the produced emulsion droplet and controlling the pitch of the emulsion droplet generation.

The foregoing written specification is considered to be sufficient to enable one skilled in the art to practice the invention. The present invention is not to be limited in scope by examples provided, since the examples are intended as a single illustration of one aspect of the invention and other functionally equivalent embodiments are within the scope of the invention. Various modifications of the invention in addition to those shown and described herein will become apparent to those skilled in the art from the foregoing description and fall within the scope of the appended claims. Certain advantages and objects of the invention are not necessarily encompassed by each embodiment of the invention.

While several embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### Non-Limiting Exemplary Embodiments of the Invention

Embodiment 1. An emulsification device comprising: an outer tank, an inner tank, and a pressure source,

1) wherein the outer tank is configured to house a first liquid,

wherein the outer tank comprises a first pressing end and a first exit end,

wherein the first pressing end is configured to pass a pressure from the pressure source onto the first liquid,

wherein the first exit end has an opening through which the first liquid flows out under the pressure;

2) wherein the inner tank configured to house a second liquid,

wherein the inner tank comprises a second pressing end and a second exit,

wherein the second pressing end is configured to pass a pressure onto the second liquid,

wherein the second exit end has an opening through which the second liquid flows out under the pressure,

wherein the inner tank is inside the outer tank, and

wherein the first pressing end, the second pressing end, the second exit end and the first exit end are sequentially aligned in order of the first pressing end, the second pressing end, the second exit end and the first exit end; and

3) wherein the pressure source is configured to be connected to the first pressing end and to provide a pressure, wherein when the pressure is applied to the first pressing end from the pressure source, said pressure is also simultaneously passed and applied through the second pressing end.

Embodiment 2. The emulsification device of Embodiment 1, wherein the first liquid and the second liquid are immiscible.

Embodiment 3. An emulsification method comprises

providing an emulsification device comprising an outer tank and an inner tank,

wherein the outer tank is filled with a first liquid and the inner tank is filled with a second liquid;

wherein the inner tank filled with the second liquid is inside the outer tank filled with the first liquid;

thereby the first pressing end, the second pressing end, the second exit end and the first exit end are sequentially aligned in order of the first pressing end, the second pressing end, the second exit end and the first exit end;

applying a pressure to the first liquid through a pressure source connected to the first pressing end, wherein the pressure is simultaneously passed through the second pressing end and applied to the second liquid, wherein under the pressure the first liquid flows towards the first exit, and the second liquid flows towards the second exit end,

wherein the second liquid flows out of the second exit end and contacts the first liquid flowing out of the first exit, resulting in formation of emulsion droplets comprising the second liquid within the first liquid.

Embodiment 4. The emulsification method of Embodiment 3, wherein the outer tank that has a volume less than 5000 μl, and the inner tank has a volume less than 4000 μl, wherein the outer tank is filled with the first liquid, and wherein the inner tank is filled with the second liquid.

Embodiment 5. The emulsification method of Embodiment 3, wherein:

the first exit end is open and has an opening, wherein the opening of the first exit end has a linear size less than 5000 microns; and

the second exit end is open and has an opening, wherein the opening of the second exit end has a linear size less than 4000 microns.

Embodiment 6. An emulsification device comprising.

an outer tank having two opposite ends, one of which is a first pressing end and the other is a first exit end; and

an inner tank having two opposite ends, one of which is a second pressing end and the other is a second exit end,

wherein when the emulsification device is in use, the inner tank is disposed inside the outer tank and the second exit end is located closer than the second pressing end to the first exit end, the outer tank is configured to house a first liquid and the inner tank is configured to house a second liquid, the first and second exit ends are open, and the first and second pressing ends are arranged so that a pressure can be applied simultaneously onto both the first and second liquids from the first and second pressing ends, and

wherein under the pressure, the first liquid flows towards the first exit end and the second liquid flows towards the second exit end,

wherein the second liquid flows out of the inner tank through the second exit end and contacts with the first liquid in the outer tank, thereby an emulsion droplet comprising the second liquid within the first liquid is formed out of the second exit end.

Embodiment 7. The emulsification device of Embodiment 6, wherein the inner tank and the outer tank are arranged so that the first pressing end, the second pressing end, the second exit end and the first exit end are sequentially aligned in order of the first pressing end, the second pressing end, the second exit end and the first exit end.

Embodiment 8. The emulsification device of Embodiment 6, wherein the second pressing end is flush with the first pressing end, and wherein the second pressing end, the second exit end and the first exit end are sequentially aligned in order of the second pressing end, the second exit end and the first exit end.

Embodiment 9. The emulsification device of Embodiment 6, wherein:

the first exit end is sized so that the first liquid at the first exit end has a surface tension sufficient to keep the first liquid from flowing out of the outer tank without applying the pressure onto the first liquid; and

the second exit end is sized so that the second liquid at the second exit end has a surface tension sufficient to keep the second liquid from flowing out of the inner tank without applying the pressure onto the second liquid.

Embodiment 10. The emulsification device of Embodiment 6, further comprising a 30 pressure source which is configured to provide a single pressure onto both the first liquid from the first pressing end and the second liquid from the second pressing end.

Embodiment 11. The emulsification device of Embodiment 10, wherein the pressure source is a gas pump, and when the emulsification device is in use, a pressured gas is supplied from the gas pump onto both the first and second liquids.

Embodiment 12. The emulsification device of Embodiment 11, wherein the first pressing end is sealed with a lid so that the whole body of the inner tank with the second pressing end is contained in the outer tank, and the pressured gas is supplied into the outer tank after passing through a hole of the lid.

Embodiment 13. The emulsification device of Embodiment 6, further comprising a holder disposed inside the outer tank, wherein the holder holds the inner tank inside the outer tank.

Embodiment 14. The emulsification device of Embodiment 6, wherein the emulsification device further comprises a means for holding the inner tank inside the outer tank.

Embodiment 15. The emulsification device of Embodiment 14, wherein the holder is a plate having an edge part configured to be attached with an inner wall of the outer tank, and there is a first hole and one or more second holes on the plate,

wherein the first hole is configured for holding the inner tank inside the outer tank, and the one or more second holes are configured for the first liquid in the outer tank to flow through.

Embodiment 16. The emulsification device of Embodiment 6, wherein the second exit end has a linear size smaller than a linear size of the first exit end.

Embodiment 17. The emulsification device of Embodiment 6, wherein the first exit end has a linear size ranging from 0.01 mm to 2.0 mm, and the second exit end has a linear size ranging from 0.007 mm to 1.8 mm.

Embodiment 18. The emulsification device of Embodiment 6, wherein each of the outer tank and the inner tank has a tapered shape.

Embodiment 19. The emulsification device of Embodiment 6, wherein each of the outer tank and the inner tank comprises a top section having a cylinder shape with a first diameter, a bottom section having a cylinder shape with a second diameter smaller than the first diameter, and a third section having a shape of a truncated cone, wherein the truncated cone connects the top section and the bottom section,

wherein the first pressing end is one end of the top section of the outer tank,

wherein the second pressing end is one end of the top section of the inner tank,

wherein the first exit is one end of the bottom section of the outer tank, and

wherein the second exit is one end of the bottom section of the inner tank.

Embodiment 20. An emulsification method implemented with an emulsification device comprising an outer tank and an inner tank, wherein the emulsification method comprises: filling the outer tank with a first liquid, and filling the inner tank with a second liquid,

wherein the outer tank has two opposite ends, one of which is a first pressing end and the other is a first exit end which is open, the inner tank has two opposite ends, one of which is a second pressing end and the other is a second exit end which is open, and the inner tank is disposed inside the outer tank in such a manner that the second exit end is located closer than the second pressing end to the first exit end;

applying a pressure onto the first and second liquids simultaneously from the first and second pressing ends so that under the pressure, the first liquid flows towards the first exit end and the second liquid flows towards the second exit end, wherein the second liquid flows out of the inner tank through the second exit end and contacts with the first liquid in the outer tank to form an emulsion droplet comprising the second liquid within the first liquid.

Embodiment 21. The emulsification method of Embodiment 20, wherein the first liquid is in an oil phase, and the second liquid is in an aqueous phase.

Embodiment 22. The emulsification method of Embodiment 21, wherein the first and/or the second liquid contain one or more surfactants.

Embodiment 23. The emulsification method of Embodiment 22, further comprising:

adjusting total number of droplets to be generated by changing a volume of the inner tank.

Embodiment 24. The emulsification method of Embodiment 20, further comprising:

adjusting a flow ratio of the first liquid to the second liquid by changing a relative position of the inner tank to the outer tank.

Embodiment 25. The emulsification method of Embodiments 20-24, wherein the average droplet volume is in the range from 1 picoliter to 150 microliter.

1. An emulsification device comprising:
an outer tank, an inner tank, and a pressure source,
1) wherein the outer tank is configured to house a first liquid,
wherein the outer tank comprises a first pressing end and a first exit end,
wherein the first pressing end is configured to pass a pressure from the pressure source onto the first liquid,
wherein the first exit end has an opening through which the first liquid flows out under the pressure;
2) wherein the inner tank configured to house a second liquid,
wherein the inner tank comprises a second pressing end and a second exit,
wherein the second pressing end is configured to pass a pressure onto the second liquid,
wherein the second exit end has an opening through which the second liquid flows out under the pressure,
wherein the inner tank is inside the outer tank, and
wherein the first pressing end, the second pressing end, the second exit end and the first exit end are sequentially aligned in order of the first pressing end, the second pressing end, the second exit end and the first exit end; and
3) wherein the pressure source is configured to be connected to the first pressing end and to provide a pressure, wherein when the pressure is applied to the first pressing end from the pressure source, said pressure is also simultaneously passed and applied through the second pressing end.

2. The emulsification device of claim 1, wherein the first liquid and the second liquid are immiscible.

3. An emulsification method comprises
providing an emulsification device comprising an outer tank and an inner tank,
wherein the outer tank is filled with a first liquid and the inner tank is filled with a second liquid;
wherein the inner tank filled with the second liquid is inside the outer tank filled with the first liquid;
thereby the first pressing end, the second pressing end, the second exit end and the first exit end are sequentially aligned in order of the first pressing end, the second pressing end, the second exit end and the first exit end;
applying a pressure to the first liquid through a pressure source connected to the first pressing end, wherein the pressure is simultaneously passed through the second pressing end and applied to the second liquid, wherein under the pressure the first liquid flows towards the first exit, and the second liquid flows towards the second exit end,
wherein the second liquid flows out of the second exit end and contacts the first liquid flowing out of the first exit, resulting in formation of emulsion droplets comprising the second liquid within the first liquid.

4. The emulsification method of claim 3, wherein the outer tank that has a volume less than 5000 μl, and the inner tank has a volume less than 4000 μl, wherein the outer tank is filled with the first liquid, and wherein the inner tank is filled with the second liquid and/or
the first exit end is open and has an opening, wherein the opening of the first exit end has a linear size less than 5000 microns; and
the second exit end is open and has an opening, wherein the opening of the second exit end has a linear size less than 4000 microns.

5. (canceled)

6. An emulsification device comprising:
an outer tank having two opposite ends, one of which is a first pressing end and the other is a first exit end; and
an inner tank having two opposite ends, one of which is a second pressing end and the other is a second exit end,
wherein when the emulsification device is in use, the inner tank is disposed inside the outer tank and the second exit end is located closer than the second pressing end to the first exit end, the outer tank is configured to house a first liquid and the inner tank is configured to house a second liquid, the first and second exit ends are open, and the first and second pressing ends are arranged so that a pressure can be applied simultaneously onto both the first and second liquids from the first and second pressing ends, and
wherein under the pressure, the first liquid flows towards the first exit end and the second liquid flows towards the second exit end,
wherein the second liquid flows out of the inner tank through the second exit end and contacts with the first liquid in the outer tank, thereby an emulsion droplet comprising the second liquid within the first liquid is formed out of the second exit end.

7. The emulsification device of claim 6, wherein the inner tank and the outer tank are arranged so that the first pressing end, the second pressing end, the second exit end and the first exit end are sequentially aligned in order of the first pressing end, the second pressing end, the second exit end and the first exit end.

8. The emulsification device of claim 6, wherein the second pressing end is flush with the first pressing end, and wherein the second pressing end, the second exit end and the first exit end are sequentially aligned in order of the second pressing end, the second exit end and the first exit end.

9. The emulsification device of claim 6, wherein:
the first exit end has a linear size configured to keep the first liquid from flowing out of the outer tank without applying the pressure onto the first liquid; and
the second exit end has a linear size configured to keep the second liquid from flowing out of the inner tank without applying the pressure onto the second liquid.

10. The emulsification device of claim 6, further comprising a pressure source which is configured to provide a single pressure onto both the first liquid from the first pressing end and the second liquid from the second pressing end.

11. The emulsification device of claim 10, wherein the pressure source is a gas pump, and when the emulsification device is in use, a pressured gas is supplied from the gas pump onto both the first and second liquids.

12. The emulsification device of claim 11, wherein the first pressing end is sealed with a lid so that the whole body of the inner tank with the second pressing end is contained in the outer tank, and the pressured gas is supplied into the outer tank after passing through a hole of the lid.

13. The emulsification device of claim 6, further comprising a holder disposed inside the outer tank, wherein the holder holds the inner tank inside the outer tank, and
Optionally the emulsification device further comprises a means for holding the inner tank inside the outer tank.

14. (canceled)

15. The emulsification device of claim 13, wherein the holder is a plate having an edge part configured to be attached with an inner wall of the outer tank, and there is a first hole and one or more second holes on the plate,
wherein the first hole is configured for holding the inner tank inside the outer tank, and the one or more second holes are configured for the first liquid in the outer tank to flow through.

16. The emulsification device of claim 6, wherein the second exit end has a linear size smaller than a linear size of the first exit end,
wherein the first exit end has a linear size ranging from 0.01 mm to 2.0 mm, and the second exit end has a linear size ranging from 0.007 mm to 1.8 mm, and/or,
wherein each of the outer tank and the inner tank has a tapered shape.

17-18. (canceled)

19. The emulsification device of claim 6, wherein each of the outer tank and the inner tank comprises a top section having a cylinder shape with a first diameter, a bottom section having a cylinder shape with a second diameter smaller than the first diameter, and a third section having a shape of a truncated cone, wherein the truncated cone connects the top section and the bottom section,
wherein the first pressing end is one end of the top section of the outer tank,
wherein the second pressing end is one end of the top section of the inner tank,
wherein the first exit is one end of the bottom section of the outer tank, and
wherein the second exit is one end of the bottom section of the inner tank.

20. An emulsification method implemented with an emulsification device comprising an outer tank and an inner tank, wherein the emulsification method comprises:
filling the outer tank with a first liquid, and filling the inner tank with a second liquid, wherein the outer tank has two opposite ends, one of which is a first pressing end and the other is a first exit end which is open, the inner tank has two opposite ends, one of which is a second pressing end and the other is a second exit end which is open, and the inner tank is disposed inside the outer tank in such a manner that the second exit end is located closer than the second pressing end to the first exit end;
applying a pressure onto the first and second liquids simultaneously from the first and second pressing ends so that under the pressure, the first liquid flows towards the first exit end and the second liquid flows towards the second exit end, wherein the second liquid flows out of the inner tank through the second exit end and contacts with the first liquid in the outer tank to form an emulsion droplet comprising the second liquid within the first liquid.

21. The emulsification method of claim 20, wherein the first liquid is in an oil phase, and the second liquid is in an aqueous phase, and/or
the average droplet volume is in the range from 1 picoliter to 150 microliter.

22. The emulsification method of claim 21, wherein the first and/or the second liquid contains one or more surfactants.

23. The emulsification method of claim 19, further comprising:
adjusting total number of droplets to be generated by changing a volume of the inner tank.

24. The emulsification method of claim 20, further comprising:
adjusting a flow ratio of the first liquid to the second liquid by changing a relative position of the inner tank to the outer tank.

25. (canceled)
